(19) United States
(12) Patent Application Publication
(10) Pub. No.: US 2004/0015361 A1
(43) Pub. Date: Jan. 22, 2004

(54) Encoding media data for decompression at remote computers employing automatic decoding options

(76) Inventor: Richard W. Bloomstein, Highland Park, IL (US)

Correspondence Address: RICHARD W. BLOOMSTEIN, 1443 CAVELL STREET, HIGHLAND PARK, IL, 60035-2807, US

(21) Appl. No.: 10/400,749

(22) Filed: Mar. 27, 2003

Related U.S. Application Data
(60) Provisional application No. 60/397,075, filed on Jul. 22, 2002.

(51) Int. Cl. G10L 11/00

(52) U.S. Cl. 704/270.1

(57) ABSTRACT

The present invention encodes speech segments in a manner in which they can be transmitted as compressed digital signals accompanying a document and decompressed and played automatically by remote computers without pre-arrangement, direct intervention or apparent delay in interactive networks such as the Internet.

Unlike the prior art, the present invention checks for a plurality of decompression program code routines that may be present at a remote computer. By checking from a list the chances of finding appropriate code is improved. If, however, none is present, directly executable decompression code is sent along with the compressed speech segments. Once sent, the code may be re-posited for later re-use in the remote computer without direct authorization or security problems.

### CROSS-REFERENCE TO RELATED APPLICATIONS

This invention covers improvements to U.S. patent application Ser. No. 09/683,524 filed Jan. 14, 2002.

This invention was filed as a provisional patent application No. 60/397,075 on Jul. 22, 2002.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

The object of the present invention is to encode speech segments in a manner in which they can be transmitted as compressed digital signals accompanying a document and decompressed and played automatically and in an efficient manner by remote computers without pre-arrangement, direct intervention or apparent delay in interactive networks such as the Internet. Although directed toward speech, the invention is applicable to a variety of media.

Currently, speech data associated with a document is encoded in a relatively inefficient uncompressed digital format so that it is acceptable directly by most remote computers or is encoded in a compressed format that requires pre-arranged reception and/or requires the recipient at a remote computer to make one or more affirmative authorizations to initiate selection, transmission, decompression and playing.

For example, U.S. Pat. No. 5,261,027 entitled “Code excited linear prediction speech coding system” to Taniguchi et. al. shows that digital speech can be compressed. U.S. Pat. No. 5,883,891, “Method and apparatus for increased quality of voice transmission over the Internet”, to Williams et. al. shows that digitized speech can be transmitted over the Internet. U.S. Pat. No. 5,915,001, “System and method for providing and using universally accessible voice and speech data files” to Uppaluru shows that speech files can be associated with Internet documents. U.S. Pat. No. 5,991,781, “Method and apparatus for detecting and presenting client side image map attributes including sound attributes using pag layout data strings” to Ni Isen shows that HTML documents us d in the Internet can have links to multiple speech segments. U.S. Pat. No. 6,138,089, “Apparatus system and method for speech compression and decompression” to Guberman shows that speech signals on the Internet can be highly compressed and still retain high fidelity voice quality.

One limitation of all of the above references is that a pre-arrangement must be made to convey the program instructions to decompress the sound data at the receiving computer. Further, such conveyance requires direct affirmation by the recipient.

An article by L. Richard Moore, “How Do I Create a Streaming Audio Java Applet” overcomes the pre-arrangement limitation by transmitting the program instructions to decompress the along with the sound data but still requires direct affirmation by the recipient. Moreover, the technique described involves time delays which would be apparent to the recipient and a degradation of quality and compression efficiency.

By overcoming these limitations the present invention would allow, for example, sales suggestions, news releases, navigation aids, etc. to be included with documents on the Internet in a more pleasing manner without requiring authorizing mouse clicks, apparent delays, or a specific pre-loaded decoding and decompression routines.

### BRIEF SUMMARY OF THE INVENTION

The present invention encodes speech segments in a manner in which they can be transmitted as compressed digital signals accompanying a document and decompressed and played automatically by remote computers without pre-arrangement, direct intervention or apparent delay in interactive networks such as the Internet.

Unlike the prior art, the present invention checks for a plurality of decompression program code routines that may be present at a remote computer. Thus time spent in transmitting the program code that decompresses the encoded sound is reduce. By checking from a list the chances of finding appropriate code is improved.

Another improvement consists of preparing a number of compression formats of the same speech segment and transmitting a suitable format based on selection code executed at a remote computer without requiring intervention by the person at the remote computer.

Another improvement consists of transmitting decompression code along with sound data after checking and finding no suitable decompression code present at a remote computer again, without requiring intervention by the person at the remote computer.

Another improvement consists of storing all or part of the decompression program code transmitted as described above for later use without prompting the person at the remote computer or presenting security problems.

### BRIEF DESCRIPTION OF THE SEVERAL VIEWS OF THE DRAWING

FIG. 1 includes compressed sound and selection code included in a document transmitted to remote computers on a network.

FIG. 2 includes the execution of the selection code in a remote computer in which decompression code is present.

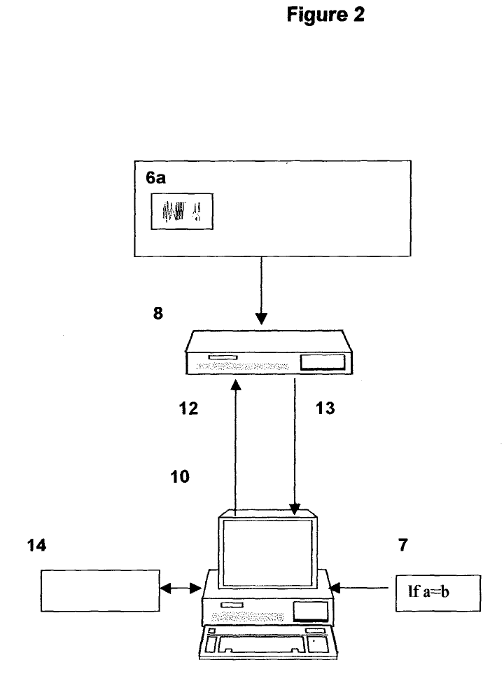

FIG. 3 depicts an alternative to FIG. 2 corresponding to a situation in which no installed decompression program code is detected.

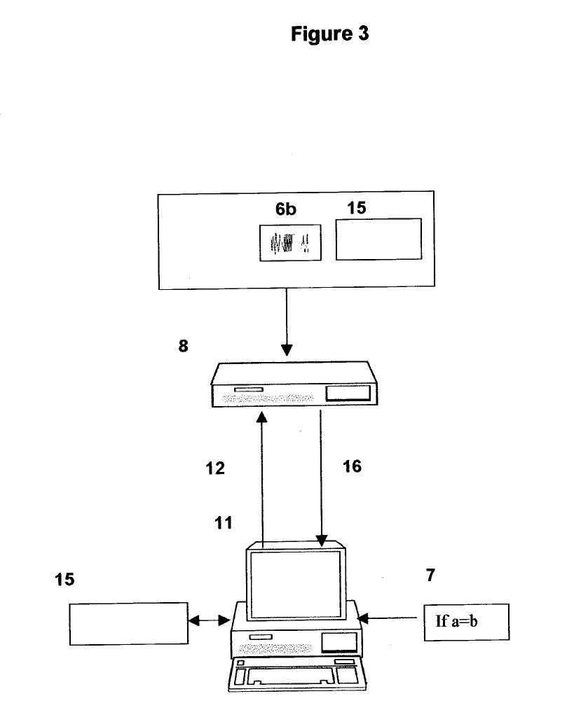

Item 4 depicts sound encoded in uncompressed digital format.

Item 5 depicts a document and components associated with it.

Item 6a depicts a compressed format of the encoded sound in 4.

Item 6b depicts an alternative compressed format of sound in 4.

Item 7 depicts program code to select from alternative formats.

Item 8 depicts a service computer.

Item 9 depicts a network such as the Internet.

Item 10 depicts a remote computer which contained decompression program code prior to transmission of any part of the document.

Item 11 depicts a remote computer which did not contain decompression program code prior to transmission of any part of the document.

Item 12 depicts signals representing the identity of a selected format or decompression code.

Item 13 depicts the compressed sound encoded in a format corresponding to information in the signals in 12.

Item 14 depicts previously installed program code which is capable of decoding decompressing the format in 13.

Item 15 depicts decompression code suitable for transmission to and executable in a remote computer

Item 16 depicts the compressed sound and decompression code transmitted to the remote computer of FIG. 11.

### DETAILED DESCRIPTION OF THE INVENTION

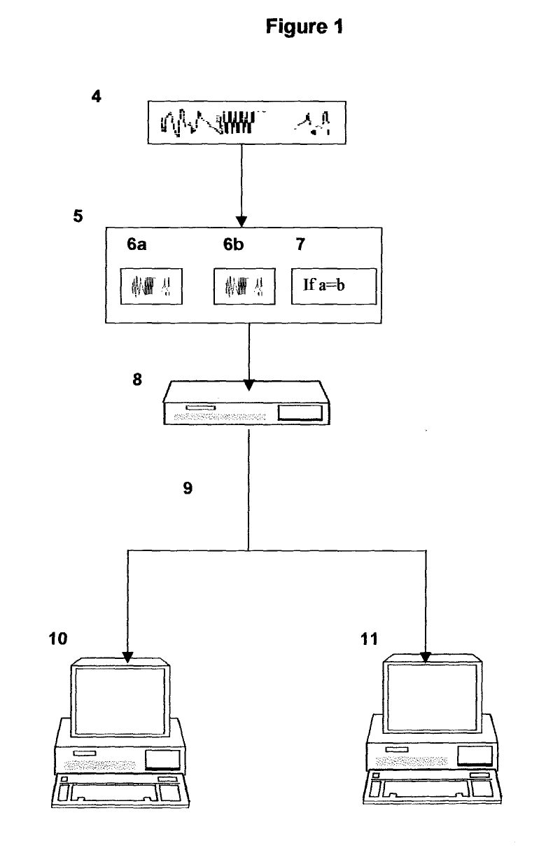

Referring first to FIG. 1 sound encoded in uncompressed format (4) is re-encoded into one or more alternative compressed formats (6a, 6b) along with selection code (7) and stored with a document (5) on a service computer (8). Parts of the document including the selection code (7) is transmitted to remote computer(s) (10, 11) on a network such as the Internet (9).

In the preferred embodiment sets of instructions suitable for retrieving, decompressing, and playing compressed speech data at a remote computer is also stored on a digital computer (8) which transmits documents to remote computers. The instructions to be executed at remote computers are written in a language directly executable by the browser or network program residing in remote computers. An example of such browsers residing in r mote computers is the Internet Explorer manufactured by Microsoft Corporation. An example of language directly executable by such a brows r is th Java language and VB Script.

The control routines and the decompression code (7) are coded in a form exacutable in normally expected remote computers (10, 11) directly within a network environment and included with the compressed media data (6a, 6b) within a document (5). For example, in an Internet environment the decompression code may be a Java applet, script, or embedded commands. (Most other language formats require a pre-arranged download that must be authorized by the viewer at the remote computer).

The initial portion of the document (5), the speech controlling code and the decompression code (7), and the compressed data (6a, 6b) may be transmitted by any network, for example the Internet, that connects the transmitting and receiving computers.

In the preferred embodiment, the instructions controlling the receipt of speech data and activation of the decompression code are transmitted and activated with the initial portion of the document. Although several options are available to specify retrieval of the compressed speech data, the preferred embodiment retrieves the compressed speech data by executing instructions in this initial portion.

In the preferred embodiment additional control routines decompress and play speech segments based on one or more appropriate events at the remote computer. For example, a welcome message can be initiated automatically when the document is

What I claim as my invention is:

1. A method of encoding documents in an interactive network so as to play digitally compressed media including program means for selecting a player program present at viewer/listener's terminal without direct action by the viewer/listener.

2. A method in claim 1 where the network is the Internet

3. A document encoded according to claim 2

4. A method in claim 2 including program means for playing digitally compressed speech segments without direct authorization or pre-arrangement by the viewer/listener.

5. A method in claim 1 including program means to transmit program means to play compressed speech if no player program in a selection list is present.

6. A method in claim 5 where the network is the Internet.

7. A document encoded according to claim 6.

8. A method in claim 5 in which the program means to transmit program means to play requires no direct authorization by the viewer/listener.

9. A method in claim 8 where the network is the Internet.

10. A method for transmitting to and storing program code in a remote computer without requiring authorization by a person at the remote computer on a public network.

11. A method in claim 10 where such program code contains information to decompress media data.

12. A method in claim 8 where the network is the Internet.

13. A document encoded according to claim 10.
